(19) United States
(12) Patent Application Publication
(10) Pub. No.: US 2019/0005531 A1
(43) Pub. Date: Jan. 3, 2019

(54) INFORMATION PROCESSING APPARATUS, SERVER, AND INFORMATION PROCESSING SYSTEM

(71) Applicant: CANON KABUSHIKI KAISHA, Tokyo (JP)

(72) Inventor: Takuya Hatakeyama, Kawasaki-shi (JP)

(21) Appl. No.: 16/023,235

(22) Filed: Jun. 29, 2018

(30) Foreign Application Priority Data
Jun. 30, 2017 (JP) 2017-129190

(51) Int. Cl. G06Q 30/02

(52) U.S. Cl. CPC G06Q 30/0226

(57) ABSTRACT

An information processing apparatus includes: a generation unit configured to generate log information; a storage control unit configured to store the generated log information in a storage unit; and a transmission unit configured to transmit the stored log information. The transmission unit transmits log information stored before registration of the information processing apparatus as a target apparatus of a reward point service which uses the log information, after the registration of the information processing apparatus as a target apparatus of the reward point service.

### BACKGROUND OF THE INVENTION

### Field of the Invention

The present invention relates to an information processing technique that assists provision of a reward point service.

### Description of the Related Art

In recent years, there have been provided reward point services (the reward point services are also called a loyalty program), which grant points in accordance with the price of a purchase, frequent-flyer programs, which grant miles in accordance with the distance of travel on a flight, and similar programs. With these reward point services, users can receive rewards equivalent to the points they earned, while the companies providing the reward point services can encourage the users to purchase their products and services.

These reward point services have been provided also in the technical field of printers. For example, there is a reward point service that grants points in accordance with the amounts of the inks used in a printer and the like. Further, Japanese Patent Laid-Open No. 2012-024958 discloses a reward point service assistance system that, in a case where the amounts of inks used increase due to correction of a color shift, grants more points than normal in accordance with the increase in an attempt to improve the level of the service for users.

### SUMMARY OF THE INVENTION

An object of the present invention is to provide enough motivation to use a reward point service to users not using the reward point service.

An information processing apparatus of the present invention includes: a generation unit configured to generate log information; a storage control unit configured to store the generated log information in a storage unit; and a transmission unit configured to transmit the stored log information, and the transmission unit transmits log information stored before registration of the information processing apparatus as a target apparatus of a reward point service which uses the log information, after the registration of the information processing apparatus as a target apparatus of the reward point service.

Further features of the present invention will become apparent from the following description of exemplary embodiments with reference to the attached drawings.

### BRIEF DESCRIPTION OF THE DRAWINGS

FIG. 1 is a diagram illustrating an exemplary entire configuration of a reward point service assistance system in an embodiment;

FIG. 2 is a block diagram illustrating an exemplary schematic configuration of an MFP in the embodiment;

FIG. 3 is a block diagram illustrating an exemplary schematic configuration of a log collection server in the embodiment;

FIG. 4 is a block diagram illustrating an exemplary schematic configuration of a point counting server in the embodiment;

FIG. 5 is a flowchart illustrating an exemplary procedure of a reward point service process in the embodiment;

FIG. 6 is a sequence chart illustrating an exemplary procedure of a process performed at the time of installing the MFP in the embodiment;

FIG. 7 is a sequence chart illustrating an exemplary procedure of transmitting an event log in the embodiment;

FIG. 8 is a sequence chart illustrating an exemplary procedure of issuing a provisional ID in the embodiment;

FIG. 9 is a sequence chart illustrating an exemplary procedure of storing an event log in the embodiment;

FIGS. 10A and 10B are diagrams illustrating specific examples of an event log in the embodiment;

FIG. 11 is a sequence chart illustrating an exemplary procedure of transmitting gathered logs in the embodiment;

FIG. 12 is a sequence chart illustrating a process performed at the time of starting using the reward point service in the embodiment;

FIG. 13 is a sequence chart illustrating an exemplary procedure of issuing a definitive ID in the embodiment;

FIG. 14 is a diagram illustrating specific examples of a point coefficient in the embodiment; and

FIG. 15 is a diagram illustrating the correspondences between MFP registration statuses and the contents of log-related processes in the embodiment.

### DESCRIPTION OF THE EMBODIMENTS

The technique in Japanese Patent Laid-Open No. 2012-024958 can improve the service level for users using the reward point service but cannot provide enough motivation to use the reward point service to users not using the reward point service.

An embodiment of the present invention will be described below with reference to the drawings. Note that the configurations described in this embodiment are mere examples and are not intended to limit the scope of the present invention to those.

### Embodiment

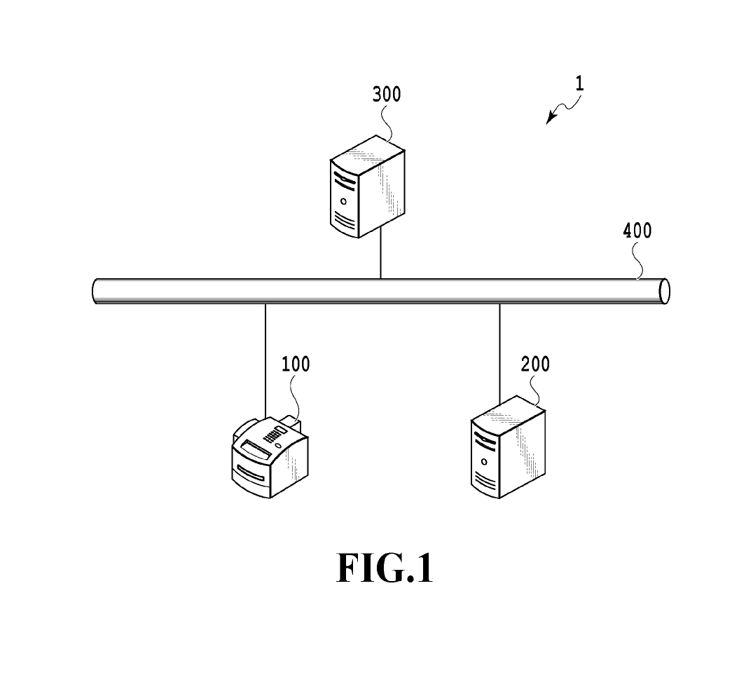

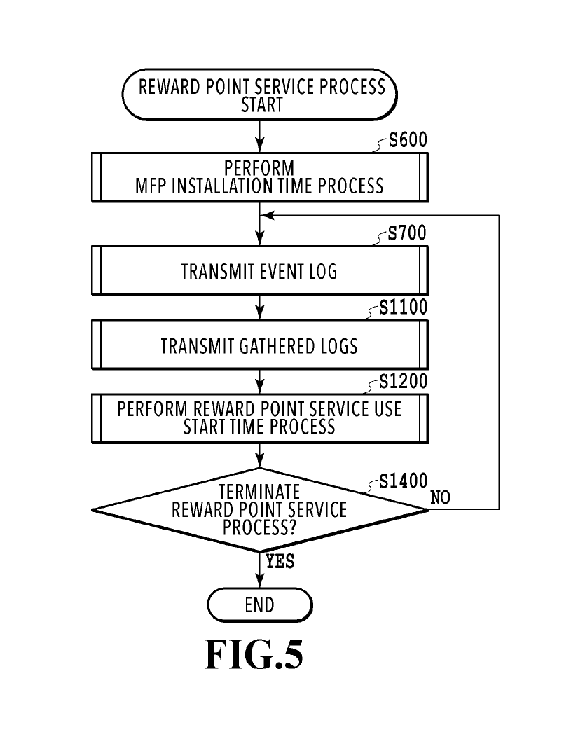

FIG. 1 is a diagram illustrating an exemplary entire configuration of a reward point service assistance system 1 (information processing system) in this embodiment. The reward point service assistance system 1 includes a multi-function peripheral (MFP) 100, a log collection server 200, and a point counting server 300, which are connected to each other communicatively through a communication network 400. In a case where the MFP 100 is connected to the communication network 400 for the first time, the MFP 100 communicates with the log collection server 200 (and the point counting server 300) and executes a reward point service process (FIG. 5). In a case where an event such execution of a print job or replacement of an ink tank takes place, the MFP 100 generates log information and transmits the log information (event log) to the log collection server 200. Details of the transmission of the event log will be described later. The service that grants rewards points like this is also called a loyalty program.

The log collection server 200 transmits gathered logs obtained by gathering event logs collected from the MFP 100 to the point counting server 300 at daily intervals. For example, in a case where the MFP 100 transmits an event log to the log collection server 200 three times a day, the log collection server 200 transmits gathered logs to the point counting server 300 once a day. Details of the transmission of the gathered logs will be described later.

The point counting server 300 calculates points based on gathered logs, sums up points on a monthly basis, grants the points at the beginning of the next month, and manages the granted points with a valid period set for the granted points. In this embodiment, description will be given on the assumption that the valid period for a point is one year from the granting of the point. Also, in a case where the MFP 100 is registered in the log collection server 200 as an apparatus from which to collect logs, the log collection server 200 communicates with the point counting server 300 and creates an account for managing points granted to the MFP 100. Moreover, the log collection server 200 creates an ID and a password necessary for logging in to this account and notifies the MFP 100 of these. The user of the MFP 100 can use this ID and password to log in to the point counting server 300 (point management account) through a browser that operates on a PC or mobile terminal not illustrated. Then, once logging in to the point counting server 300, the user of the MFP 100 check the points granted to the MFP 100 and their valid periods. Also, the user can redeem points earned by the MFP 100 for an accessory of the MFP 100 as well. Meanwhile, in a case where the MFP 100 has not transmitted any event log to the log collection server 200 for one year since the registration of the MFP 100 in the log collection server 200, it means that the reward point service has not been used for a long time. In this case, the log collection server 200 unregisters the MFP 100. Communication between the MFP 100 and the log collection server 200 and communication between the log collection server 200 and the point counting server 300 can be controlled by a publicly known control protocol such as HTTP or XMPP A publicly known method other than the above control protocols may be used to control these communications.

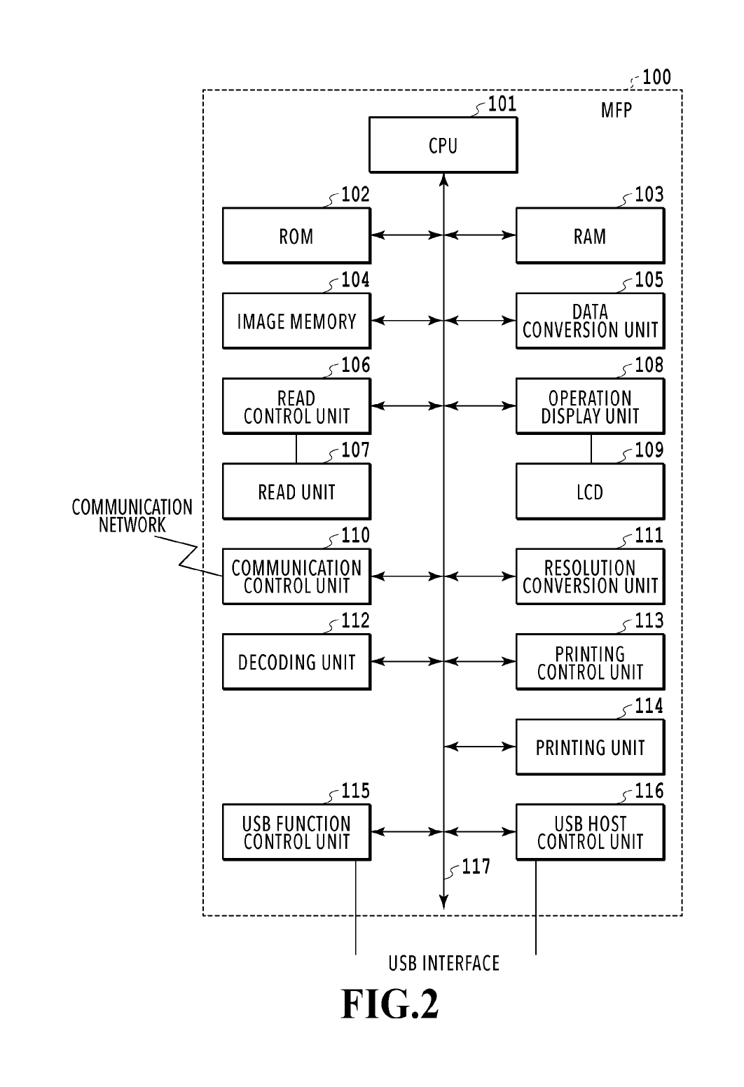

FIG. 2 is a block diagram illustrating an exemplary schematic configuration of the MFP 100 in this embodiment. The MFP 100 in this embodiment has information processing functions such as the creation, recording, and transmission of event logs and further has an image forming function of forming an image on a printing medium by means of a printing control unit 113 and a printing unit 114 to be described later. In other words, the MFP 100 can be seen as an image forming apparatus. A CPU 101 is a system control unit and controls the whole MFP 100. An ROM 102 stores fixed data such as control programs executed by the CPU 101, data tables, and an embedded operating system (OS). In this embodiment, the control programs stored in the ROM 102 undergo software execution control such as scheduling, task switching, and interrupt processes under the control of the embedded OS stored in the ROM 102. The RAM 103 is configured of a static random access memory (SRAM) or the like that requires a backup power source, and a primary battery not illustrated for data backup guarantees the supply of power to the RAM 103. The RAM 103 stores program control variables and so on. Also, in the RAM 103, a memory area is provided for storing event logs in cases where the MFP 100 cannot transmit the event logs, such as a case where the MFP 100 is not connected to the communication network 400. Also, in the RAM 103, a memory area is provided for storing a plurality of pieces of information to be used in the reward point service as well. Writing and reading various pieces of data to and from the RAM 103 in the MFP 100 in this embodiment under the control of the CPU 101 can be considered a form of a storage control unit. An image memory 104 is configured of a dynamic random access memory (DRAM) or the like and can accumulate image data. Also, an area in the image memory 104 is left as a work area for executing software processes. A data conversion unit 105 can perform image data conversion such as analysis of a page description language (PDL), decompression of the computer graphics (CG) of character data.

A read unit 107 optically reads a document by means of a CIS image sensor and converts it into an electric image signal. A read control unit 106 performs various types of image processing such as a binarization process and a halftone process on this image signal and outputs high-definition image data. Note that the method of optically reading a document may be either a sheet read control method in which the document is read by a fixed CIS image sensor or a book read control method in which the document fixed on a document table is read by a moving CIS image sensor.

An operation display unit 108 includes minimum keys such as numerical value input keys, mode setting keys, an enter key, and a cancel key as well as a light emitting diode (LED), a seven-segment display unit, and so on. The above various keys are implemented as so-called softkeys displayed on an LCD 109 and can receive operations from the user. In a case where no user operation is performed for a predetermined period of time, the LCD 109 turns off the backlight of the LCD 109 in order to lower the power consumption. The operation display unit 108 (the LCD 109) can also display a warning that points will expire and a warning that the MFP 100 might be unregistered from the reward point service.

A communication control unit 110 controls communication between the MFP 100 and the communication network 400; it establishes a connection to an Internet service provider and communicates various pieces of data to and from the log collection server 200 and the point counting server 300. The communication control unit 110 can also determine whether the MFP 100 is connected to the Internet or connected only to an LAN. Note that the connection between the communication control unit 110 and the communication network 400 is based on a publicly known method such as HTTP or XMPP. A resolution conversion unit 111 performs a resolution conversion process such as mutual conversion between millimeter-based image data and inch-based image data. Note that the resolution conversion unit 111 can also execute an image data rescaling process. A decoding unit 112 performs a decoding process and a rescaling process on image data handled in the MFP 100 (such as uncompressed, MH, MR, MMR, JBIG, or JPEG image data). The printing control unit 113 performs various types of image processing such as a smoothing process, a record density correction process, and color correction on image data to be printed to thereby convert the image data into high-definition image data and outputs it to the printing unit 114.

The printing unit 114 is configured of a laser beam printer, an inkjet printer, or the like and prints image data generated by the printing control unit 113 onto a printing medium such as a paper sheet.

The USB function control unit 115 performs communication control at an USB interface in conformity with a USB communication standard. Specifically, the USB function control unit 115 converts data from a USB function control task into packets and transmits the converted packets to a PC not illustrated, or conversely converts USB packets received from the PC into particular data and transmits it to the CPU 101. The USB host control unit 116 is a control unit for performing communication with the protocol specified by a USB communication standard. This USB communication standard is a standard for bidirectional high-speed data communication. This USB communication standard specifies that a plurality of hubs or functions (slaves) are connectable to a single host (master). In other words, the USB host control unit 116 provides the function of a host in USB communication. The components other than the read unit 107 and the LCD 109 are connected to each other by a bus 117.

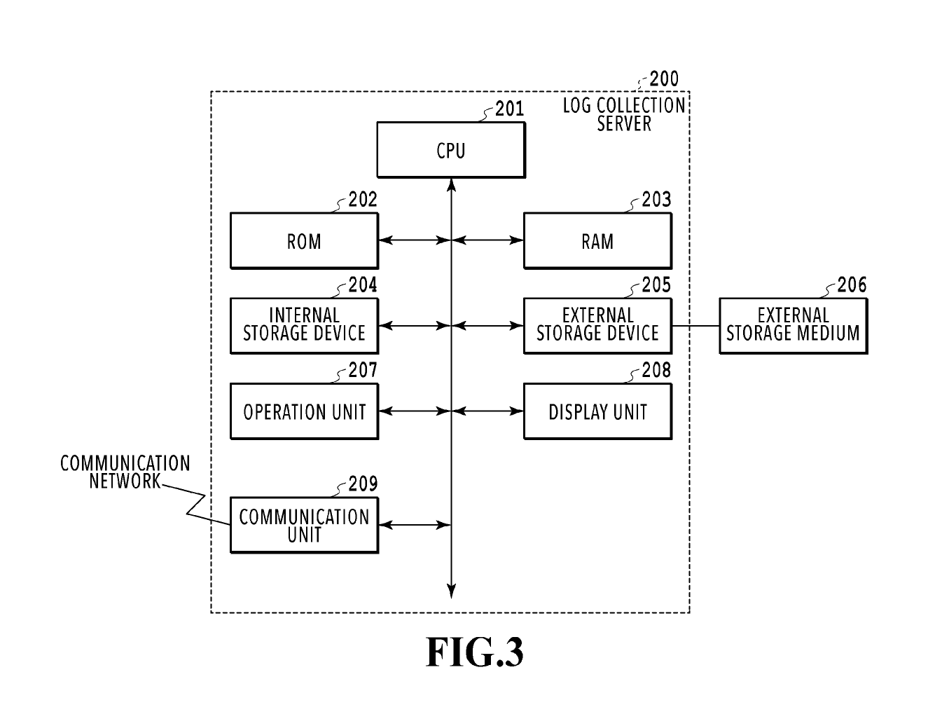

FIG. 3 is a block diagram illustrating an exemplary schematic configuration of the log collection server 200 in this embodiment. A CPU 201 controls the operation of the whole log collection server 200 in accordance with a program read from an ROM 202, an RAM 203, an internal storage device 204, or an external storage medium 206 to an external storage device 205. The ROM 202 stores a control program for the CPU 201 and so on. The RAM 203 temporarily stores programs and image data and allows the log collection server 200 to perform its processing operations at high speed. The internal storage device 204 stores an operating system, various application programs, image data, and so on. Also, in the internal storage device 204, there are installed application software for transmitting and receiving various control commands and data to and from the MFP 100 and the point counting server 300 and so on. Also, the internal storage device 204 stores event logs received from the MFP 100, monthly unused points obtained from the point counting server 300, and so on. An operation unit 207 is an input device such as a keyboard and a mouse, for example, and receives instruction inputs from the operator of the log collection server 200. A display unit 208 displays various pieces of information to the operator. A communication unit 209 is connected to the communication network 400, establishes a connection to the Internet provider, and communicates various pieces of data to and from the MFP 100 and the point counting server 300. Note that the connection to the communication network 400 is based on a publicly known method such as HTTP or XMPP.

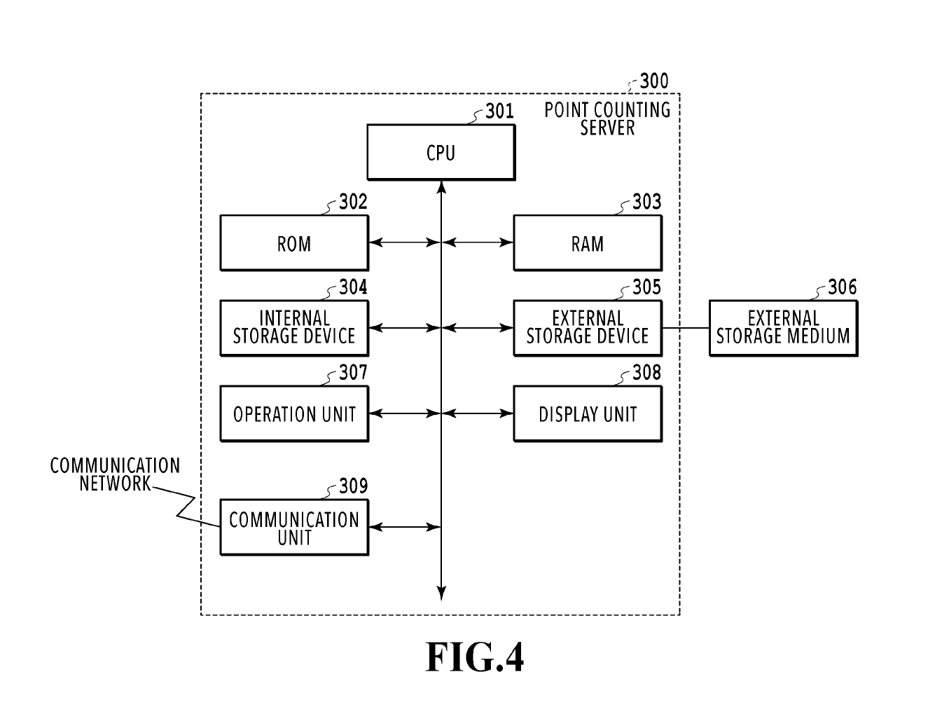

FIG. 4 is a block diagram illustrating an exemplary schematic configuration of the point counting server 300 in this embodiment. The components other than an internal storage device 304 are similar to the components of the log collection server 200 in FIG. 3, and description thereof will thus be omitted. The internal storage device 304 stores an operating system, various application programs, image data, and so on. Also, in the internal storage device 304, there are installed application software for transmitting and receiving various control commands and data to and from the log collection server 200 and so on. Also, the point counting server 300 analyzes the contents of gathered logs received at daily intervals from the log collection server 200 and stores points to be granted based on the analysis result. Also, in a case where the user redeems points for a reward, the internal storage device 304 subtracts the used points from the unused points stored in the internal storage device 304.

FIG. 5 is a main flowchart illustrating an exemplary procedure of the reward point service process in this embodiment. The CPUs of the MFP 100, the log collection server 200, and the point counting server 300 decompress program codes stored in the respective ROMs into the respective RAMs and execute them to perform the processing of the flowchart illustrated in FIG. 5. Each reference sign S in the following means a step in the flowchart or sequence chart. This applies also to the flowcharts and sequence charts following FIG. 5.

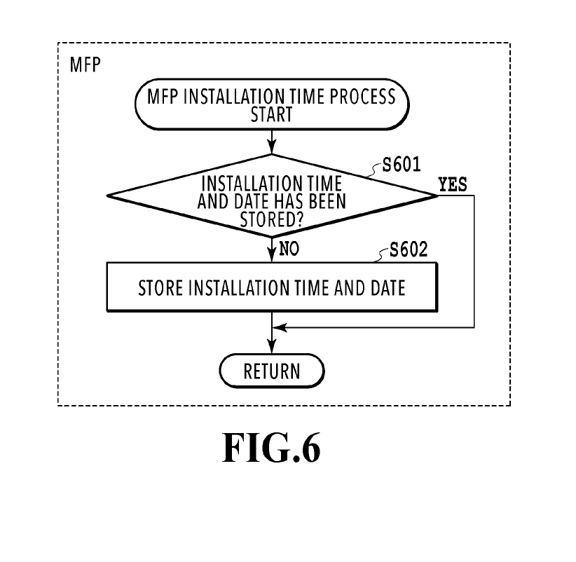

In S600, an MFP installation time process is performed. The MFP installation time process will be described with reference to the sequence chart in FIG. 6.

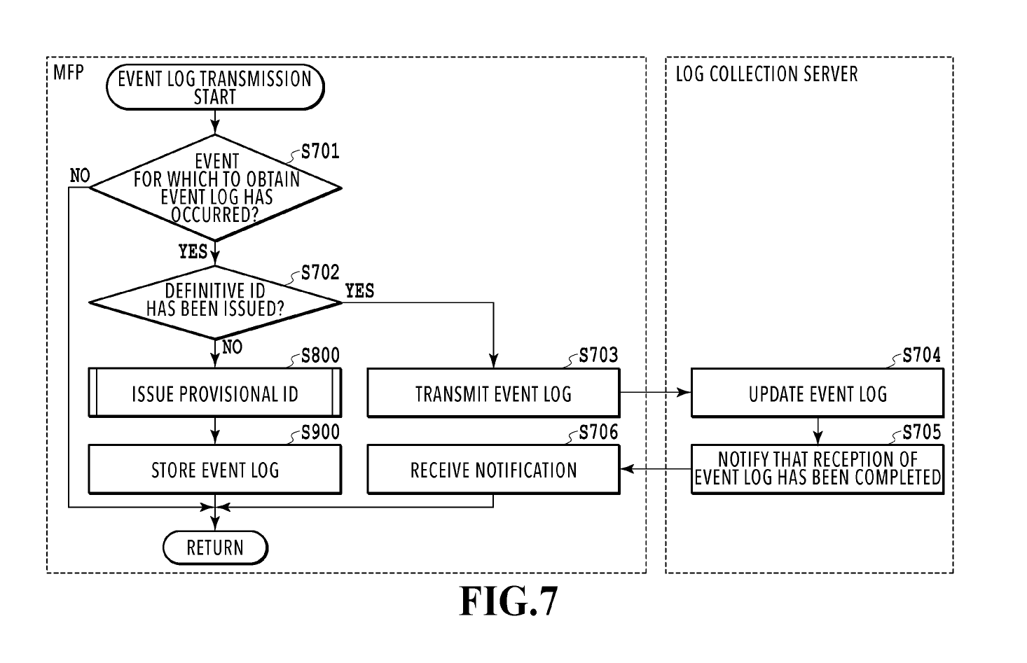

In S700, an event log transmission process is performed. The event log transmission process will be described with reference to the sequence charts in FIGS. 7 to 9.

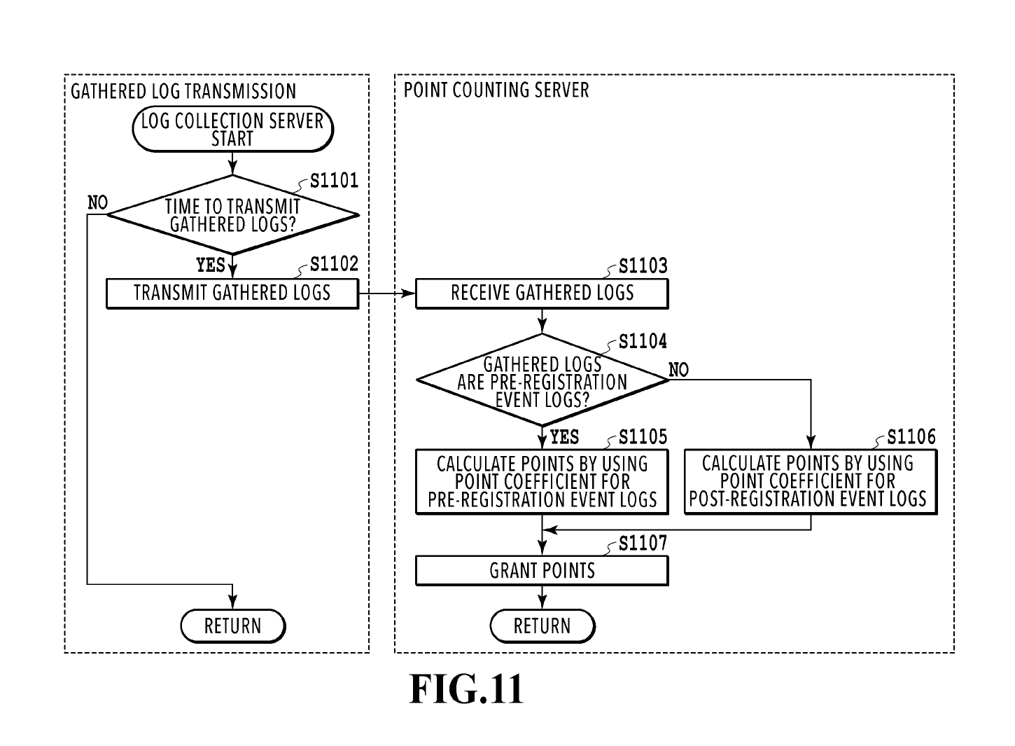

In S1100, a gathered log transmission process is performed. The gathered log transmission process will be described with reference to the sequence chart in FIG. 11.

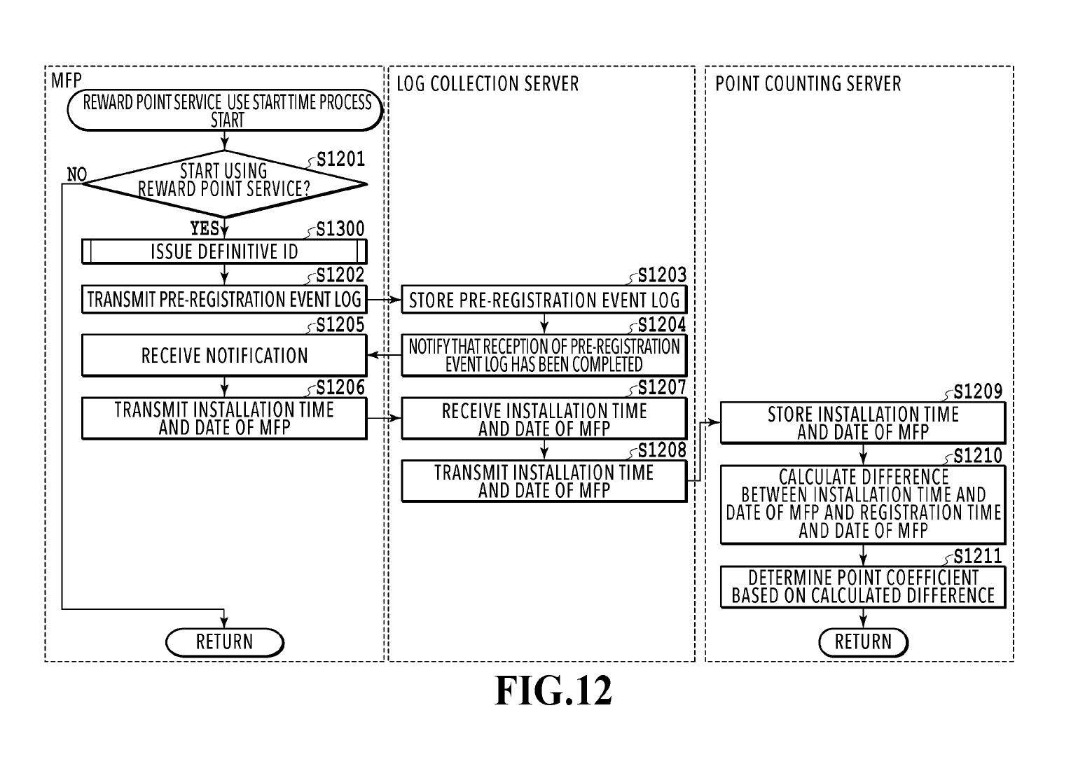

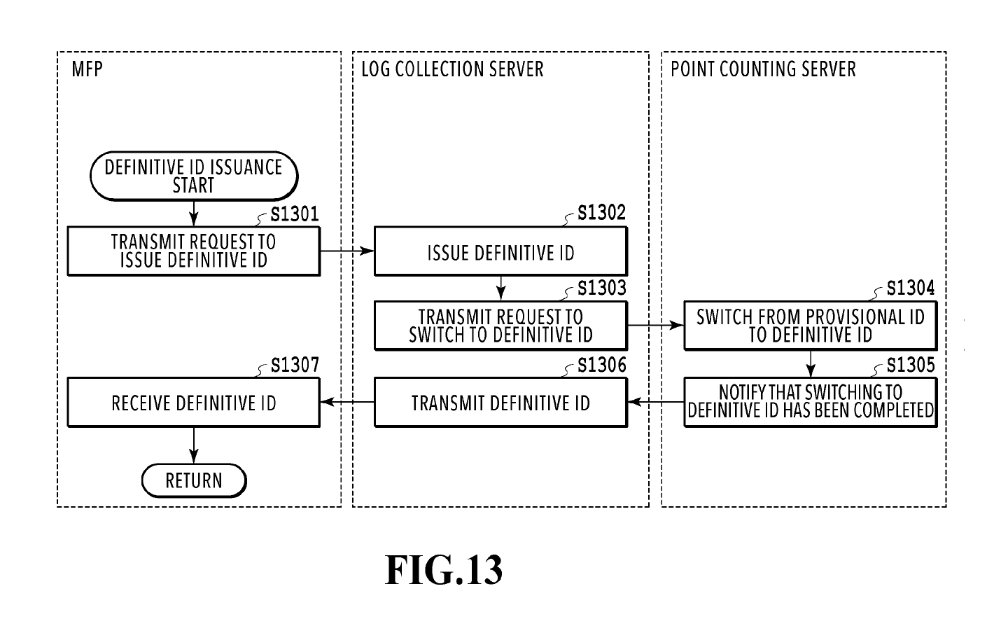

In S1200, a reward point service use start time process is performed. The reward point service use start time process will be described with reference to the sequence charts in FIGS. 12 and 13.

In S1400, whether or not to terminate the reward point service process is determined. Whether or not to terminate the reward point service process can be determined based on, for example, whether or not transmission of an event log is completed or whether or not a predetermined period of time has elapsed since gathered logs were transmitted. This flowchart is terminated in a case where the reward point service process is terminated (S1400. YES). S700 to S1200 are repeated in a case where the reward point service process is not terminated (S1400: NO).

FIG. 6 is a sequence chart illustrating an exemplary procedure of a process performed at the time of installing the MFP in this embodiment. The sequence illustrated in FIG. 6 is executed in a case where the MFP 100 is installed at a predetermined location and connected to the communication network 400 as illustrated in FIG. 1 for the first time.

In S601, the MFP 100 determines whether or not the installation time and date on which the MFP 100 was installed are already stored in a storage area in the RAM 103 or the like. In a case where the installation time and date are already stored (S601: YES), the MFP 100 skips S602 to terminate the process of this sequence chart, and the processing returns to the main flowchart. In a case where the installation time and date are not stored (S601: NO), the MFP 100 stores the installation time and date on which the MFP 100 was installed in the storage area in the RAM 103 or the like in S602. After the storing of the installation time and date is completed (S602), the process of this sequence chart is terminated and the processing returns to the main flowchart.

FIG. 7 is a sequence chart illustrating an exemplary procedure of transmitting an event log in this embodiment.

In S701, the MFP 100 determines whether or not an event for which to obtain an event log has occurred such as execution of a print job or replacement of an ink tank. In a case where an event for which to obtain an event log has occurred (S701: YES), the MFP 100 proceeds to a determination process in S702. In a case where an event for which to obtain an event log has not occurred (S701: NO), the process of this sequence chart is terminated, and the processing returns to the main flowchart.

In S702, the MFP 100 determines whether or not a definitive ID has been issued by the log collection server 200. Specifically, the MFP 100 determines whether or not a definitive ID that has been issued is stored in a storage area in the RAM 103 or the like. In a case where the definitive ID has been issued (S702: YES), the MFP 100 proceeds to S703. In a case where the definitive ID has not been issued (S702: NO), the MFP 100 proceeds to a provisional ID issuance process in S800.

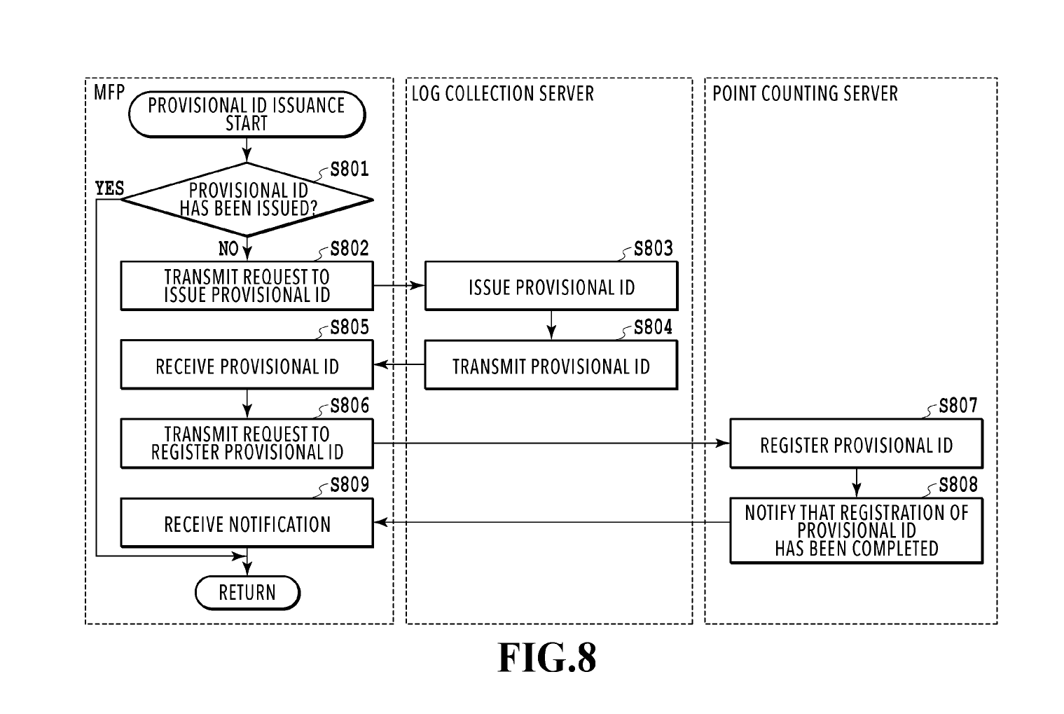

FIG. 8 is a sequence chart illustrating an exemplary procedure of issuing a provisional ID in this embodiment. In the reward point service assistance system 1 in this embodiment, a provisional ID is issued first from the log collection server 200. This is because the MFP 100 needs to uniquely identify the log of the event that occurred. In other words, the provisional ID, issued from the log collection server 200, is used as an identifier of the log of the event that occurred. Meanwhile, in this embodiment, in a case where the MFP 100 is registered as a target apparatus of the reward point service (S1201: YES), a definitive ID is issued from the log collection server 200. This definitive ID is used as an identifier of event logs in the MFP 100 and also used to manage the account of the MFP 100 in the servers.

In S801, the MFP 100 determines whether or not the provisional ID has been issued by the log collection server 200. In a case where the provisional ID has been issued (S801: YES), the process of this sequence chart is terminated, and the processing returns to the sequence chart in FIG. 7. In a case where the provisional ID has not been issued (S801: NO), the MFP 100 transmits a request to issue the provisional ID to the log collection server 200 in S802.

In S803, upon receipt of the request to issue the provisional ID from the MFP 100, the log collection server 200 issues the provisional ID.

In S804, the log collection server 200 transmits the issued provisional ID to the MFP 100.

In S805, the MFP 100 receives the provisional ID from the log collection server 200.

In S806, the MFP 100 receives an input of agreement to terms from the user through the operation display unit 108 and transmits a request to register the provisional ID, issued in S803, to the point counting server 300.

In S807, the point counting server 300 registers the provisional ID of the MFP 100.

In S808, the point counting server 300 notifies the MFP 100 that the registration of the provisional ID has been completed.

In S809, the MFP 100 receives the notification of the completion of the registration of the provisional ID. Then, after the process of S809 is completed, this sequence is terminated, and the processing returns to the sequence chart in FIG. 7.

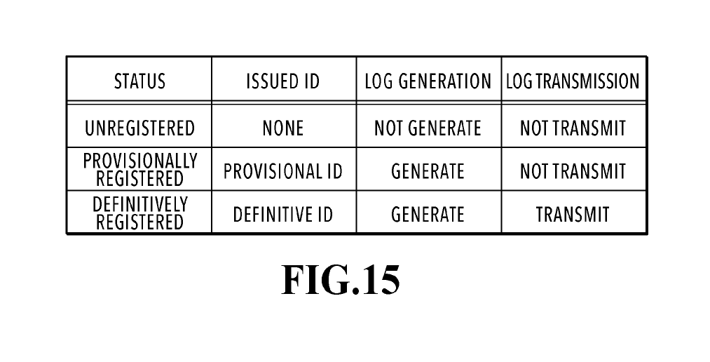

Referring back to the sequence chart in FIG. 7, the MFP 100 stores a log of the event that occurred, in S900 after the provisional registration. Meanwhile, in FIG. 7, the MFP 100 always proceeds to the provisional ID issuance process in S800 in a case where determining in S702 that the definitive ID has not been issued; however, this embodiment is not limited to this case. Specifically, a step of determining “whether to use the reward point service” (use confirmation step) may be added between S702 and S800. In this case, the MFP 100 may proceed to S800 in a case where determining in the use confirmation step that the reward point service is to be used, whereas the process of the sequence chart in FIG. 7 is terminated in a case where the MFP 100 determines that the reward point service is not to be used. In the case where the MFP 100 determines that the reward point service is not to be used and the process is terminated as above, the MFP 100 is in a state where the MFP 100 is not registered for the reward point service (a state where the MFP 100 is not even provisionally registered). Hence, the MFP 100 generates (or records) no log, as illustrated in FIG. 15. On the other hand, in a case where the MFP 100 is provisionally registered (not definitive registration) as in S800, the MFP 100 generates (and records) a log. Then, after being definitively registered, the MFP 100 sends the logs accumulated in the previous, provisionally registered state.

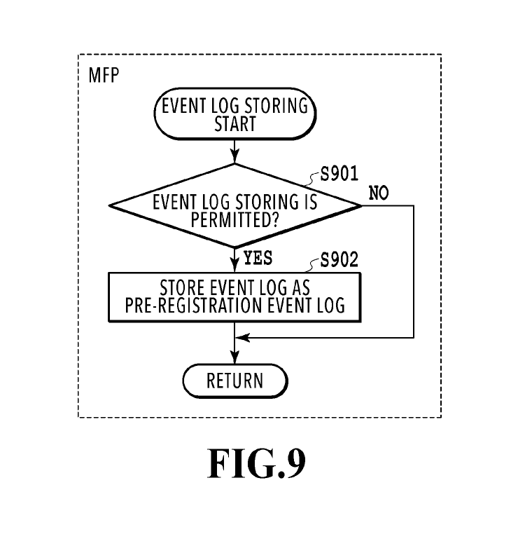

Also, although the provisional ID is issued (that is, provisional registration is performed) in FIG. 7, this embodiment is not limited to this case. Specifically, instead of the step of “issuing the provisional ID”, a step of determining “whether log storing is permitted” (log storing permission confirmation step) may be performed. In this case, the user chooses a setting about whether “to permit log storing in the MFP 100” in advance. Then, based on that setting, a log is stored and accumulated in a case where log storing is permitted, whereas no log is stored and the process is terminated in a case where log storing is not permitted. Details of this will be described using FIG. 9.

FIG. 9 is a sequence chart illustrating a procedure based on this setting about whether to permit event log storing. The MFP 100 in this embodiment determines whether or not to store an obtained event log in a storage area in the RAM 103 or the like, based on whether or not event log storing is permitted by the user.

In S901, the MFP 100 determines whether or not event log storing in the MFP 100 is permitted by the user. Note that the MFP 100 can determine whether or not the event log storing is permitted, based on the user's choice received through the operation display unit 108. In a case where the event log storing is permitted by the user (S901: YES), the MFP 100 stores the log of the event that occurred in the MFP 100 as a pre-registration event log in a storage area in the RAM 103 or the like in S902. Then, after the process of S902 is completed, the process of this sequence chart is terminated, and the processing returns to the sequence chart in FIG. 7. On the other hand, in a case where the event log storing is not permitted by the user (S901: NO), the MFP 100 skips S902 to terminate this sequence, and the processing returns to the sequence chart in FIG. 7. Note that in the case of returning to the sequence of FIG. 7 from the sequence of FIG. 9, the MFP 100 skips S900 in FIG. 7 to terminate the sequence of FIG. 7, since the sequence of FIG. 9 includes the step of storing the pre-registration event log.

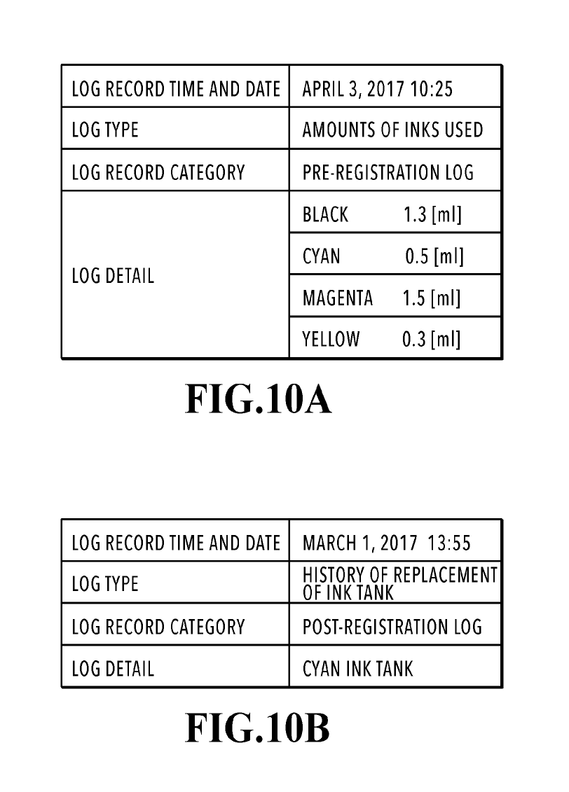

FIGS. 10A and 10B are diagrams illustrating specific examples of an event log generated by the MFP 100 in this embodiment. In this embodiment, description will be given of examples where an event log generated by the MFP 100 is the history of use of the inks used in the MFP 100. FIG. 10A is a diagram illustrating a specific example of an event log generated as a result of execution of printing in the MFP 100. The event log illustrated in FIG. 10A includes the amounts of the inks (black, cyan, magenta, and yellow) used in printing for a single print job. FIG. 10B illustrates a specific example of an event log generated as a result of replacement of an ink tank loaded in the MFP 100. The event log illustrated in FIG. 10B includes the history of replacement of an ink tank.

The event logs illustrated in FIGS. 10A and 10B contain pieces of information indicating the log record time and date, the log type, and the log record category. Among these, the log record time and date are stored on the second time scale. The log type is information indicating the type of the event log and, in this embodiment, is information capable of identifying whether the type is “the amounts of the inks used” or “the history of replacement of an ink tank.” Also, the log record category is information capable of identifying whether the event log is a log of an event that occurred before registration of the MFP 100 as a target apparatus of the reward point service or an event log that occurred after the registration. By the log record category, the event log illustrated in FIG. 10A is identified as a log of an event that occurred before the registration of the MFP 100 as a target apparatus of the reward point service. Similarly, the event log illustrated in FIG. 10B is identified as a log of an event that occurred after the registration of the MFP 100 as a target apparatus of the reward point service.

Referring back to the sequence chart in FIG. 7, the MFP 100 transmits an event log to the log collection server 200 in S703.

In S704, upon receipt of the event log from the MFP 100, the log collection server 200 stores the received event log in the internal storage device 204. In a case where any previously received event log is stored in the internal storage device 204, the log collection server 200 updates the stored event log.

In S705, the log collection server 200 notifies the MFP 100 that the reception of the event log has been completed.

In S706, the MFP 100 receives the notification from the log collection server 200. Then, after the process of S706 is completed, this sequence is terminated, and the processing returns to the main flowchart.

FIG. 11 is a sequence chart illustrating an exemplary procedure of transmitting gathered logs in this embodiment. The process of the sequence chart illustrated in FIG. 11 is executed at predetermined time intervals. In this embodiment, the event logs of the MFP 100 collected by the log collection server 200 are transmitted to the point counting server 300 at daily intervals, as described above. However, the transmission intervals are not limited to daily intervals.

In S1101, the log collection server 200 determines whether or not it is time to transmit gathered logs. In a case where it is time to transmit gathered logs (S1101: YES), the log collection server 200 proceeds to S1102. In a case where it is not time to transmit gathered logs (S1101: NO), the process of this sequence chart is terminated, and the processing returns to the main flowchart.

In S1102, the log collection server 200 gathers the one or more event logs stored in the internal storage device 204 and transmits these gathered logs to the point counting server 300. Meanwhile, in a case where the MFP 100 has been registered as a target apparatus of the reward point service (S1201: YES), any pre-registration event log stored in the internal storage device 204 (S1203) is also transmitted at this time.

In S1103, the point counting server 300 receives the gathered logs from the log collection server 200.

In S1104, the point counting server 300 analyzes the gathered logs received from the log collection server 200 and determines whether or not the gathered logs are pre-registration event logs. In a case where the gathered logs are pre-registration event logs (S1104: YES), the point counting server 300 calculates points by using a point coefficient for pre-registration event logs in S1105. Note that various methods are applicable to the calculation of points as long as a point coefficient is used. For example, in a case where an event log is the amounts of the inks used (FIG. 10A), its points can be calculated by applying a point coefficient to the sum of the amounts of the inks of all colors used. Also, in a case where an event log represents the history of replacement of an ink tank (FIG. 10B), its points can be calculated by applying a point coefficient to the price of the replaced ink tank. Alternatively, basic points may be set in advance for each type of event log.

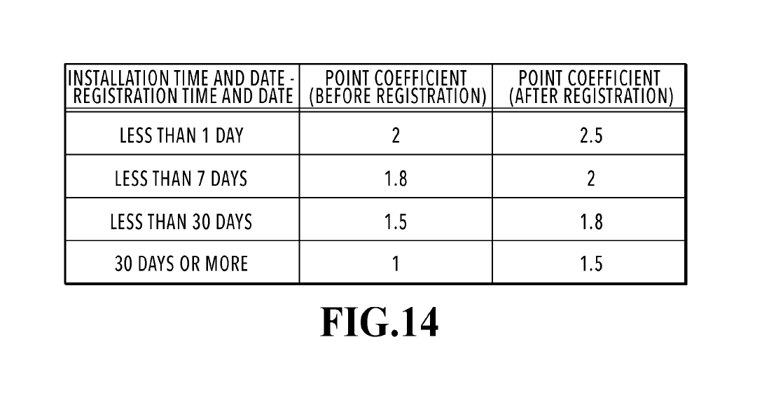

In a case where, on the other hand, the gathered logs are post-registration event logs (S1104: NO), the point counting server 300 calculates points by using a point coefficient for post-registration event logs in S1106. The point coefficients will be described later with reference to FIG. 14.

In S1107, the point counting server 300 grants the points calculated in S1105 or S1106 to the MFP 100. Then, after the process of S1107 is completed, this sequence is terminated, and the processing returns to the main flowchart.

FIG. 12 is a sequence chart illustrating a procedure of a process performed at the time of starting using the reward point service in this embodiment. In the sequence illustrated in FIG. 12, a process of registering the MFP 100 as a target apparatus of the reward point service provided by the reward point service assistance system 1 is executed. Note that the process of the sequence in FIG. 12 may be initiated in a case where it is determined that the provisional ID has been issued (S801 in FIG. 8: YES) after the provisional ID is issued in the provisional ID issuance process in FIGS. 7 and 8. Specifically, since the provisional ID has been issued, the sequence of FIG. 12 may be initiated at the time of occurrence of the first event in the MFP 100 after the issuance of the provisional ID.

In S1201, the MFP 100 determines whether or not to start using the reward point service. In this embodiment, the MFP 100 determines whether or not to start using the reward point service, based on whether or not an instruction to start using the reward point service has been received from the user. In a case where determining to start using the reward point service (S1201: YES), the MFP 100 proceeds to S1300. In a case where determining not to start using the reward point service (S1201: NO), the process of this sequence chart is terminated, and the processing returns to the main flowchart. Meanwhile, in the reward point service assistance system 1 in this embodiment, the time and date on which the instruction to start using the reward point service is received from the user (S1201: YES) are used as the registration time and date on which the MFP 100 is registered as a target apparatus of the reward point service. Note that it is also possible to omit S1201 and start the process from the next step S1300. Specifically, in the sequence of FIG. 12, the provisional ID has already been issued and it may therefore not be necessary to confirm with the user again whether or not to use the program. In the case of omitting S1201, the issuance request time and date in S1301 may be set as the registration time and date on which the MFP 100 is registered as a target apparatus of the reward point service.

FIG. 13 is a sequence chart illustrating an exemplary procedure of issuing the definitive ID in this embodiment.

In S1301, the MFP 100 transmits a request to issue the definitive ID to the log collection server 200.

In S1302, upon receipt of the request to issue to the definitive ID from the MFP 100, the log collection server 200 issues the definitive ID.

In S1303, the log collection server 200 transmits a request to switch from the provisional ID to the definitive ID to the point counting server 300.

In S1304, upon receipt of the request to switch from the provisional ID to the definitive ID from the log collection server 200, the point counting server 300 switches the provisional ID stored in the point counting server 300 to the definitive ID.

In S1305, the point counting server 300 notifies the log collection server 200 that the switching from the provisional ID to the definitive ID has been completed.

In S1306, upon receipt of the notification of the completion of the switching from the provisional ID to the definitive ID from the point counting server 300, the log collection server 200 transmits the definitive ID issued in S1303 to the MFP 100.

In S1307, the MFP 100 receives the definitive ID from the log collection server 200. Then, after the process of S1307 is completed, the process of this sequence chart is terminated, and the processing returns to the sequence chart in FIG. 12.

Referring back to the sequence chart in FIG. 12, in S1202, the MFP 100 transmits the event log stored in a storage area in the RAM 103 or the like before the reward point service starts being used (hereinafter, referred to as “pre-registration event log”) to the log collection server 200.

In S1203, upon receipt of the pre-registration event log from the MFP 100, the log collection server 200 newly stores it as an event log of the MFP 100 in the internal storage device 204.

In S1204, the log collection server 200 notifies the MFP 100 that the reception of the pre-registration event log has been completed.

In S1205, the MFP 100 receives the notification from the log collection server 200.

In S1206, the MFP 100 transmits the installation time and date of the MFP 100, stored in S601, to the log collection server 200.

In S1207, the log collection server 200 receives the installation time and date of the MFP 100 from the MFP 100.

In S1208, the log collection server 200 transmits the installation time and date received from the MFP 100 to the point counting server 300.

In S1209, the point counting server 300 receives the installation time and date from the log collection server 200 and stores them in the internal storage device 304.

In S1210, the point counting server 300 calculates the difference between the time and date on which the MFP 100 was installed and the time and date on which the MFP 100 was registered as a target apparatus of the reward point service, and stores the calculated difference in the internal storage device 304.

In S1211, the point counting server 300 determines the point coefficient based on the difference calculated in S1210. Then, after the process of S1211 is completed, this sequence is terminated, and the processing returns to the main flowchart.

FIG. 14 is a diagram illustrating specific examples of the point coefficient in this embodiment. As described above, the point coefficient in this embodiment is determined based on the difference between the installation time and date on which the MFP 100 was installed and the registration time and date on which the MFP 100 was registered as a target apparatus of the reward point service. Further, in this embodiment, different point coefficients are applied to pre-registration event logs, or logs of events that occurred before the registration of the MFP 100 as a target apparatus of the reward point service, and post-registration event logs, or logs of event that occurred after the registration. There are two reasons for applying different point coefficients as above. The first reason is that applying a higher point coefficient to post-registration event logs, or logs of events that occurred before the registration, than to pre-registration event logs can encourage the user to use the reward point service soon. The second reason is that applying the same point coefficient to all event logs might be unfair to MFPs 100 (users) registered early.

As illustrated in FIG. 14, the shorter the period from the installation time and date of the MFP 100 to the registration time and date of the MFP 100, the larger the point coefficient, and the longer the above period, the smaller the point coefficient. In one example, the point coefficient applied to a pre-registration event log is “2” in a case where the above period is 1 day or shorter, whereas the point coefficient is “1” in a case where the above period is 30 days or longer. To sum up, the earlier the MFP 100 starts using the reward point service after being installed, the larger the point coefficient applied to its pre-registration event log, and therefore the more points the MFP 100 can earn.

As described above, according to the reward point service assistance system in this embodiment, the MFP 100, constituting this system, stores a pre-registration event log, or a log of an event that occurred before the registration of the MFP 100 as a target apparatus of the reward point service. Then, in a case where the MFP 100 is registered as a target apparatus of the reward point service, the MFP 100 transmits the pre-registration event log to the log collection server 200 (and the point counting server 300) and is granted points based on this event log. Hence, the reward point service assistance system in this embodiment can provide enough motivation to use the reward point service to users not using the reward point service.

### Other Embodiments

In a reward point service assistance system 1 in another embodiment, in the case where an event log is the history of use of an expendable article, information identifying whether the expendable article is an expendable article accompanying the MFP 100 or an expendable article purchased by the user can be transmitted to the point counting server 300. Then, the point counting server 300 grants more points in the case where the event log is the history of use of an expendable article purchased by the user than in the case where the event log is the history of use of an expendable article accompanying the MFP 100. With this configuration, the reward point service assistance system 1 in this embodiment can provide motivation to purchase an expendable article such as an ink tank to the user. In addition, since points are granted also in the case where the event log is the history of use of an expendable article accompanying the MFP 100, the reward point service assistance system 1 in this embodiment can provide enough motivation to use the reward point service to the user.

In the foregoing embodiment, an event log is transmitted from the MFP 100 to the log collection server 200 each time an event for which to obtain an event log occurs in the MFP 100, and gathered logs are transmitted from the log collection server 200 to the point counting server 300 once a day. However, the intervals of transmission of logs to the servers are not limited to the above. For example, in a case where two event logs are stored in the MFP 100, the event logs may be transmitted to the log collection server 200, instead of transmitting an event log each time an event for which to obtain an event log occurs. Also, gathered logs may be transmitted from the log collection server 200 to the point counting server 300 at weekly or hourly intervals instead of daily intervals.

In the foregoing embodiment, points are counted at monthly intervals, and the valid period of a point is one year. However, the intervals and the period are not limited to the above. Points may be counted at daily intervals, and the valid period of a point may be two years from the time in a case where the point is earned.

In the foregoing embodiment, the log collection server 200 is configured to unregister the MFP 100 in a case where no event log has been transmitted from the MFP 100 for one year since the registration of the MFP 100 as a target apparatus of the reward point service. However, the period by which to unregister the MFP 100 is not limited to one year. For example, the log collection server 200 may configured to unregister the MFP 100 in a case where the period without transmission of any event log exceeds two years.

The point counting server 300 in the foregoing embodiment counts points earned in one month and then grants the points at the beginning of the next month. However, the timing to grant points is not limited to above. For example, the point counting server 300 may receive gathered logs from the log collection server 200 at daily intervals and grant points immediately after the analysis or grant points at weekly intervals, for example.

For the MFP 100 in the foregoing embodiment, targets for which to obtain an event log are events associated with ink, such as execution of a print job and replacement of an ink tank, but are not limited to these events. For example, targets for which to obtain an event log may be events such as execution of scanning by the read unit 107 and execution of faxing by a fax transmission-reception unit not illustrated.

The log collection server 200 and the point counting server 300 in the foregoing embodiment are individual servers since they provide different functions. However, the server configuration of the reward point service assistance system 1 is not limited to this. The server configuration of the reward point service assistance system 1 may be, for example, an integrated configuration in which a plurality of functions are implemented within a single server or a distributed configuration in which a plurality of functions are distributed to and implemented within more servers.

The description has been given of the example where the reward point service assistance system 1 in the foregoing embodiment includes a single MFP 100, a single log collection server 200, and a single point counting server 300. However, the server configuration in the reward point service assistance system 1 is not limited to the above. For example, the log collection server 200 and the point counting server 300 may be installed in each of service regions (such as Japan, North America, and Europe). In this case, the MFP 100 may hold information indicating the server installation locations in advance and transmit event logs to the log collection servers 200 and the point counting servers 300 installed in the service regions. In this case, by changing information indicating an event log's destination, the log collection server 200 to be accessed can be changed as well.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

The present invention brings about an advantage that enough motivation to use the reward point service can be provided to users not using the reward point service.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-129190, filed Jun. 30, 2017, which is hereby incorporated by reference wherein in its entirety.

What is claimed is:

1. An information processing apparatus comprising:
a generation unit configured to generate log information;
a storage control unit configured to store the generated log information in a storage unit; and
a transmission unit configured to transmit the stored log information, wherein
the transmission unit transmits log information stored before registration of the information processing apparatus as a target apparatus of a reward point service which uses the log information, after the registration of the information processing apparatus as a target apparatus of the reward point service.

2. The information processing apparatus according to claim 1, wherein
the storage control unit stores, in the storage unit, log information generated before the registration of the information processing apparatus as a target apparatus of the reward point service and after provisional registration thereof for the reward point service.

3. The information processing apparatus according to claim 1, wherein
the storage control unit stores the generated log information in a case where storing of log information is permitted by a user.

4. The information processing apparatus according to claim 1, wherein
the storage control unit stores log information generated between installation time and date on which the information processing apparatus was installed and registration time and date on which the information processing apparatus was registered as a target apparatus of the reward point service, and
the transmission unit transmits information on the installation time and date.

5. The information processing apparatus according to claim 1, wherein
the log information is information on a history of use of an expendable article used in the information processing apparatus.

6. The information processing apparatus according to claim 5, further comprising
a printing unit configured to form an image on a printing medium, wherein
the expendable article is an ink used by the printing unit, and
the history of use includes at least one of an amount of the ink used by the printing unit and a history of replacement of an ink tank containing the ink.

7. A server comprising:
a reception unit configured to receive log information generated by an information processing apparatus; and
a point grant unit configured to grant one or more points based on log information which is the received log information and generated before registration of the information processing apparatus as a target apparatus of a reward point service.

8. The server according to claim 7, wherein
the point grant unit calculates the points for log information generated before the registration and for log information generated after the registration by applying different point coefficients thereto.

9. The server according to claim 7, wherein
the reception unit further receives information on installation time and date on which the information processing apparatus was installed, and
the point grant unit calculates the points by applying a point coefficient corresponding to a length of a period from the installation time and date to registration time and date on which the registration was performed.

10. The server according to claim 9, wherein
the longer the period from the installation time and date to the registration time and date, the more the points are calculated.

11. The server according to claim 7, wherein
the log information is information on a history of use of an expendable article used in the information processing apparatus.

12. The server according to claim 11, wherein
the expendable article is an ink used for printing, and
the history of use includes at least one of an amount of the ink used by a printing unit of the information processing apparatus and a history of replacement of an ink tank containing the ink.

13. The server according to claim 11, wherein
the point grant unit calculates the points for a case where the history of use of the expendable article is about use of an expendable article accompanying the information processing apparatus and for a case where the history of use of the expendable article is about use of an expendable article purchased by a user of the information processing apparatus, by applying different point coefficients thereto.

14. An information processing system in which an information processing apparatus and a server are connected to each other through a communication network and which assists a reward point service that grants one or more points based on log information, wherein
the information processing apparatus comprised:
a generation unit configured to generate the log information;
a storage control unit configured to store the generated log information in a storage unit; and
a transmission unit configured to transmit the stored log information, wherein
the transmission unit transmits log information stored before registration of the information processing apparatus as a target apparatus of the reward point service, which uses the log information, to the server after the registration of the information processing apparatus as a target apparatus of the reward point service, wherein
the server includes
a reception unit configured to receive the log information generated by the information processing apparatus from the information processing apparatus, and
a point grant unit configured to grant one or more points based on log information which is the received log information and generated before the registration of the information processing apparatus as a target apparatus of the reward point service.
